(19) United States
(12) Patent Application Publication
(10) Pub. No.: US 2014/0108356 A1
(43) Pub. Date: Apr. 17, 2014

(54) INFORMATION PROCESSING APPARATUS

(71) Applicant: OKI DATA CORPORATION, Tokyo (JP)

(72) Inventor: Kouta YANAGISAWA, Tokyo (JP)

(73) Assignee: OKI DATA CORPORATION, Tokyo (JP)

(21) Appl. No.: 14/051,694

(22) Filed: Oct. 11, 2013

(30) Foreign Application Priority Data
Oct. 16, 2012 (JP) 2012-228907

(51) Int. Cl. G06F 17/30

(52) U.S. Cl. CPC G06F 17/30115
USPC 707/687

(57) ABSTRACT

An information processing apparatus includes a file saving unit for saving a first file, a state saving unit for saving, as saved state information, a second file's state at a time that the first file is saved in which the second file is opened at the time that the first file is saved, and a state reproducing unit for reproducing the second file's state to be the state at the time that the first file is saved based on the saved state information where the first file is opened after the first file is saved. The information processing apparatus allows users to re-edit files and webpages later without laboriously looking up those data again.

### CROSS REFERENCE TO RELATED APPLICATION

This application claims priority benefits under 35 USC, section 119 on the basis of Japanese Patent Application No. 2012-228907, the disclosure of which is incorporated herein by reference.

### BACKGROUND OF THE INVENTION

1. Field of the Invention

This invention relates to an information processing apparatus for accessing a file produced with a prescribed application and for editing and saving the file.

2. Description of Related Art

During an editing work for a file produced with a prescribed application, the produced file may temporarily be re-edited after booting the apparatus once shut down. Ordinary apparatuses all clear up the work states up to that time if once a shutdown is made. Users therefore have to reproduce the work state before the shutdown after booting the apparatus in order to continue the editing work.

To improve such a situation, for example, Japanese Patent Application Publication No. 2007-304914 discloses a method for reproducing the previous work state by saving the work state before the shutdown and reproducing the previous work state at a time of booting the apparatus where the file is re-edited later in the editing work of the file.

### SUMMARY OF THE INVENTION

With the method of the prior art, however, no state can be reproduced except the state of the incident application. That is, there arises a problem such that the user has to laboriously seek those files and webpages and to laboriously refer them again when the file is re-edited later in a case where doing editing work in referring information given from other files and webpages as materials and references.

It is therefore an object to provide an information processing apparatus capable of reducing laborious steps such that the user seeks other files and webpages and refers them again even when the file is re-edited later in a case where doing editing work in referring information given from other files and webpages as materials and references.

To solve the above problems, an information processing apparatus includes a file saving unit for saving a first file, a state saving unit for saving, as saved state information, a second file's state at a time that the first file is saved in which the second file is opened at the time that the first file is saved, and a state reproducing unit for reproducing the second file's state to be the state at the time that the first file is saved based on the saved state information where the first file is opened after the first file is saved.

According to the invention, the information processing apparatus can be provided for reducing laborious steps such that the user seeks other files and webpages and refers them again even when the file is re-edited later in a case where doing editing work in referring information given from other files and webpages as materials and references.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram showing a structural example of a terminal according a first embodiment of the invention;

FIG. 2 is a flowchart for describing general file editing operation according to the first embodiment;

FIG. 3A and FIG. 3B are flowcharts describing state saving operation according to the first embodiment;

FIG. 4 is a table showing a specific example of file access information according to the first embodiment;

FIG. 5 is a table showing a specific example of process information according to the first embodiment;

FIG. 6 is a table showing a specific example of webpage information according to the first embodiment;

FIG. 7 is a table showing a specific example of saved state data according to the first embodiment;

FIG. 8 is an illustration of a message box for confirmation of saved state according to the first embodiment;

FIG. 9 is a table showing a specific example of relation data according to the first embodiment;

FIG. 10 is an illustration of a message box for selection of saved state according to the first embodiment;

FIG. 11A and FIG. 11B are flowcharts describing state resuming operation according to the first embodiment;

FIG. 12 is an illustration of a message box for confirmation of resuming the previous state according to the first embodiment;

FIG. 13 is an illustration of a message box for selection of resuming the previous state according to the first embodiment;

FIG. 14 is a block diagram showing a structural example of a terminal according to a second embodiment of the invention;

FIG. 15A and FIG. 15B are flowcharts describing state saving operation according to the second embodiment;

FIG. 16 is a flowchart describing state resuming operation according to the second embodiment;

FIG. 17 is a flowchart describing operation for renewing relation information according to the second embodiment; and

FIG. 18 is a table showing a specific example of file movement information according to the second embodiment.

### DETAILED DESCRIPTION OF EMBODIMENTS

### First Embodiment

Hereinafter, referring to the drawings, an information processing apparatus according to a first embodiment of the invention is described.

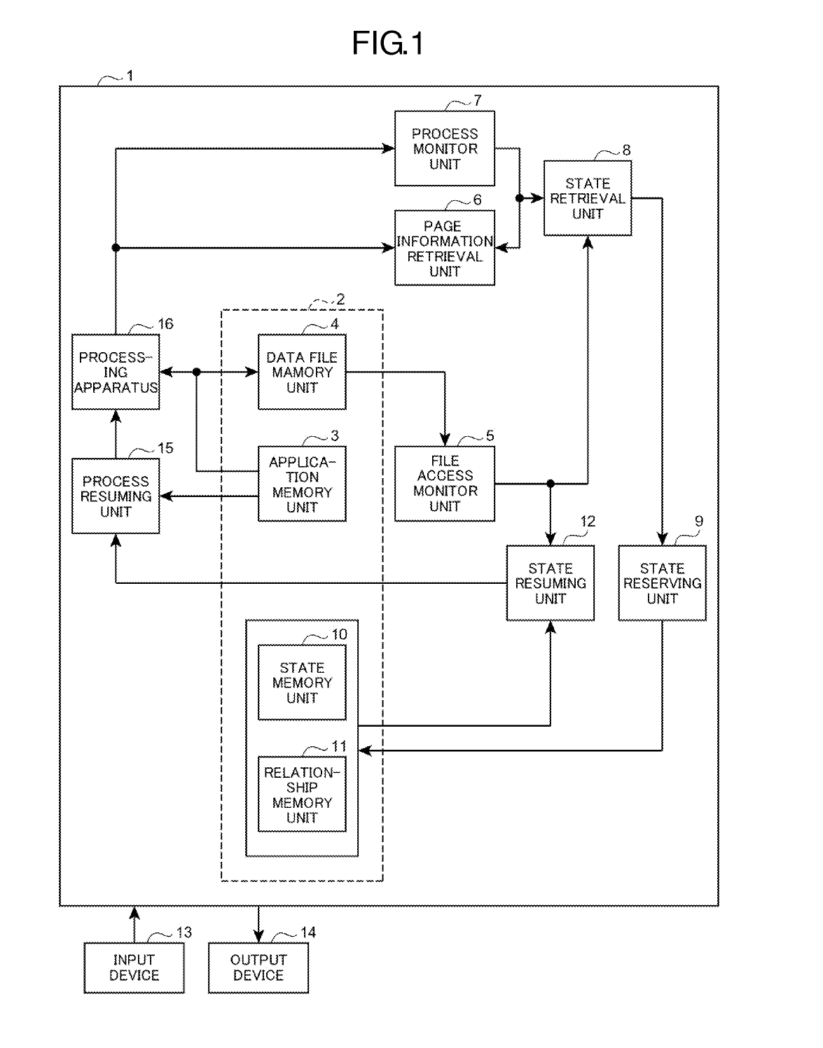

FIG. 1 is a block diagram showing a structural example of a terminal 1 as an information processing apparatus according a first embodiment of the invention. The terminal 1 can make, e.g., a personal computer or a work station, and is connected to a keyboard for inputting data to the terminal 1, an input device 13 such as, e.g., a mouse, and an output device 14 such as, e.g., a monitor displaying data entered from the terminal 1. The terminal 1 includes a CPU (Central Processing Unit) functioning a system controller, memories such as, e.g., RAMs (Random Access Memories) providing execution spaces for application software, and ROMs (Read Only Memories) storing data and programs for processing, a variety of interface units such as, e.g., a network interface including NICs (Network Interface Cards), and a storage device 2 for storing data and programs as files that can be added, deleted, and altered.

The storage device 2 can be made of, e.g., a hard disc device, and an optical disc device. The storage device 2 according to this embodiment includes an application memory unit 3, a data file memory unit 4, a state memory unit 10, and a relationship memory unit 11, but all of the data and programs stored in respective memory units are treated as files stored in the storage device 2.

A processing apparatus 16 is corresponding to the CPU described above, and realizes operation of the application software by executing the programs stored in the memories or the application memory unit 3. The processing apparatus 16 serves as a file saving unit for saving files. As specific operations executed by the application software, exemplified are processings for various calculations, and processings of additions of new files, and deletions or changes of files upon accessing the files stored in the data file memory unit 4. As general application software, exemplified are such as, e.g., word processors for opening and editing text files, music players for opening and playing music files, and web browsers for retrieving and displaying webpages upon communicating external networks.

In this specification, the application software in operation at the processing apparatus 16 is called as “process.” If an input is made to the process, the apparatus can perform executions done by the application software described above and can handle selections of files to be accessed. That is, the user of the terminal 1 can manipulate data outputting to the output device 14 and inputting to the process upon reception of the data entry via the input device 13.

The processing apparatus 16 is formed as operable with plural processes at the same time, and a process monitor unit 7 holds information on the operating processes.

A file access monitor unit 5 monitors access to a file stored in the data file memory unit 4 in the storage device 2, and holds the information therein. The file access monitor unit 5 respectively calls to activate a state resuming unit 12 in a case where detecting an access to the file stored in the data file memory unit 4 and to activate a state retrieval unit 8 in a case where the file is added or changed via the file access.

The state retrieval unit 8 collects information on the operating processes and the states of the file access from the file access monitor unit 5 and the process monitor unit 7. The state retrieval unit 8 also retrieves and collects information on the webpages displayed with the operating process such as, e.g., web browser, through the page information retrieval unit 6. The state retrieval unit 8 outputs the collected information to a state reserving unit 9.

The state reserving unit 9 produces saved state data summarizing information entered from the state retrieval unit 8 and renders the state memory unit 10 store the data. The state reserving unit 9 renders the relationship memory unit 11 store the relationship data associating the saved state data stored in the state memory unit 10 with the corresponding files. The state reserving unit 9 serves as a state saving unit for saving saved state information.

The state resuming unit 12 refers to the relationship data stored in the relationship memory unit 11 for the accessed files and reads out the corresponding saved state data from the state memory unit 10. The state resuming unit 12 activates a process resuming unit 15 based on the read-out saved state data and reproduces the state that the file is saved. The state resuming unit 12 serves as a state reproducing unit referring to the saved state information based on the relationship information. The process resuming unit 15 starts the process by operating, at the processing apparatus 16, the application software stored in the application memory unit 3 based on the instruction from the state resuming unit 12. The process resuming unit 15 renders the started process access to the files and webpages upon designating the files and webpages.

In operation of the terminal 1 according to the invention, described herein is: general file editing operation for performing file manipulations in use of application software; state reserving operation for saving information on, at a time saving a file, other files in use at the same time or concurrently, webpages being displayed concurrently, and operating application software; and state resuming operation for activating the application software, using the file, and displaying the webpages using the saved data during the state reserving operation.

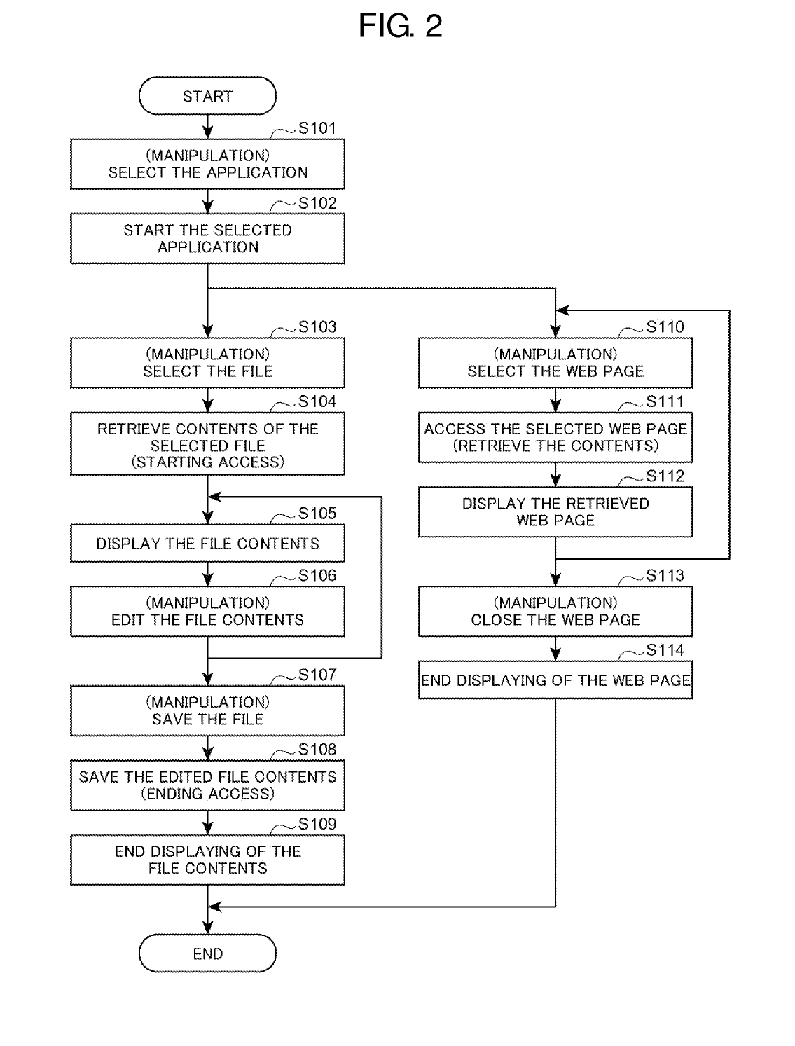

First, referring to the flowchart in FIG. 2, the general file editing operation is described. A user of the terminal 1 manipulates a process operating with the processing apparatus 16 through the input device 13 and the output device 14, thereby activating the application software stored in the application memory unit 3, and accessing the file stored in the data file memory unit 4 to edit and add the file. In the steps shown in FIG. 2, the step starting with “MANIPULATION” is a step the user does inputting.

At step S101, the user selects application software that he wants to use in the application software stored in the application memory unit 2 and starts the selected software. Because the user executes upon selection of the file or files stored in the storage device 2 or manipulates for starting the application software, it is required that file managing software, not shown, operates as a process for the processing apparatus 16. Such file managing software is installed as a basic function for the operating system in ordinary personal computers or the like, and when the user manipulates the terminal 1, it is presumed that the file managing software always operates.

The process starts (at step S102) upon booting of the selected application software. The user realizes processings and operation different according to the application software by manipulating the started process.

An operational example in a case that the application software started at step S102 performs edition of files is shown at steps S103 to S109, as an example that the incident application software is a word processor. It is to be noted that it is general to use a word processor or image editor as application software for editing files, and herein, described is the word processor as an example, but even though the word processor is used, processing contents and operational steps can be varied according to the application software, and therefore, what is shown herein is no more than an example showing a basic operational flow.

The user first selects a document file (or files) used with the word processor from the files stored in the data file memory unit 4 at step S103.

The process of the word processor makes an access to the files stored in the data file memory unit 4 with respect to the file selected by the user, and retrieves the contents of the file upon reading the contents at step S104. The process of the word processor subsequently displays the retrieved file contents at the output device 14 at step S105.

At step S106, the user manipulates editing to the file contents displayed at the output device 14. It is to be noted that the process of the word processor may change the contents to be displayed at the output device 14 according to changes of the contents done by the editing manipulation.

When the user selects saving of the file at the completion of the editing manipulation at step S107, the process of the word processor stores and saves the changed contents done by the editing manipulation in the file in the data file memory unit 4, and ends the file access at step S108. The process of the word processor then finishes displaying at the output device 14 at step S109 and completes the editing manipulation.

Next, an operational example in a case that the application software started at step S102 performs displaying webpages is shown at steps S110 to S114, as an example that the incident application software is a web browser. It is also to be noted that specific operation and processings may be varies according to the application software and that the operation described herein is merely an example.

The user first selects webpages to be displayed with the output device 14 at step S110. More specifically, the user directly enters the URLs of the webpages, or selects URLs of the webpages already registered, thereby choosing the desired webpages or websites.

The process of the web browser communicates networks using the URLs directly entered or selected by the user to retrieve the information of the webpages at step S111, thereby displaying the retrieved contents at the output device 14 at step S112. It is to be noted that the user may choose other webpages again to display the contents at the output device 14.

When the user manipulates to close the webpages displayed at the output device 14 at step S113, the process of the web browser finishes displaying the webpages at the output device 14 at step S114.

For operation of those steps, because the processing apparatus 16 can simultaneously operate plural processes, the user, when editing a certain file, can open other files at the same time as well as can do editing in referring to contents of the webpages where displaying the webpages. It is also general that application software capable of handling simultaneously plural files and webpages exists.

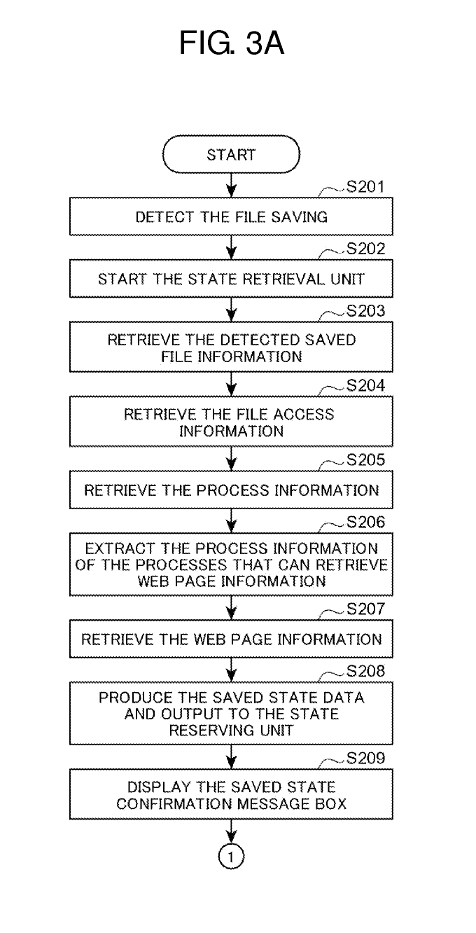

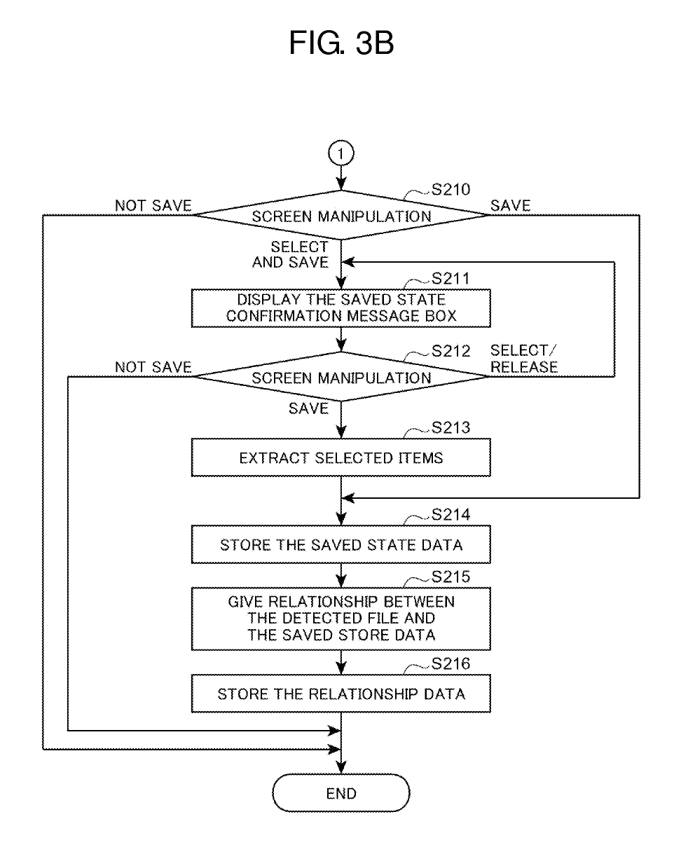

In consideration of those general file editing operations as described above, the state reserving operation is described next in referring to FIG. 3A and FIG. 3B.

As described above, the state reserving operation is started when the user saves the files, or namely, when the file access monitor unit 5 detects an access to the file stored in the data file memory unit 4 (at step S201). More specifically, the file access monitor unit 5 monitors file accesses to the file stored in the data file memory unit 4 accessed by the processing apparatus 16 and the process operating therein, and holds the information of the files under being accessed.

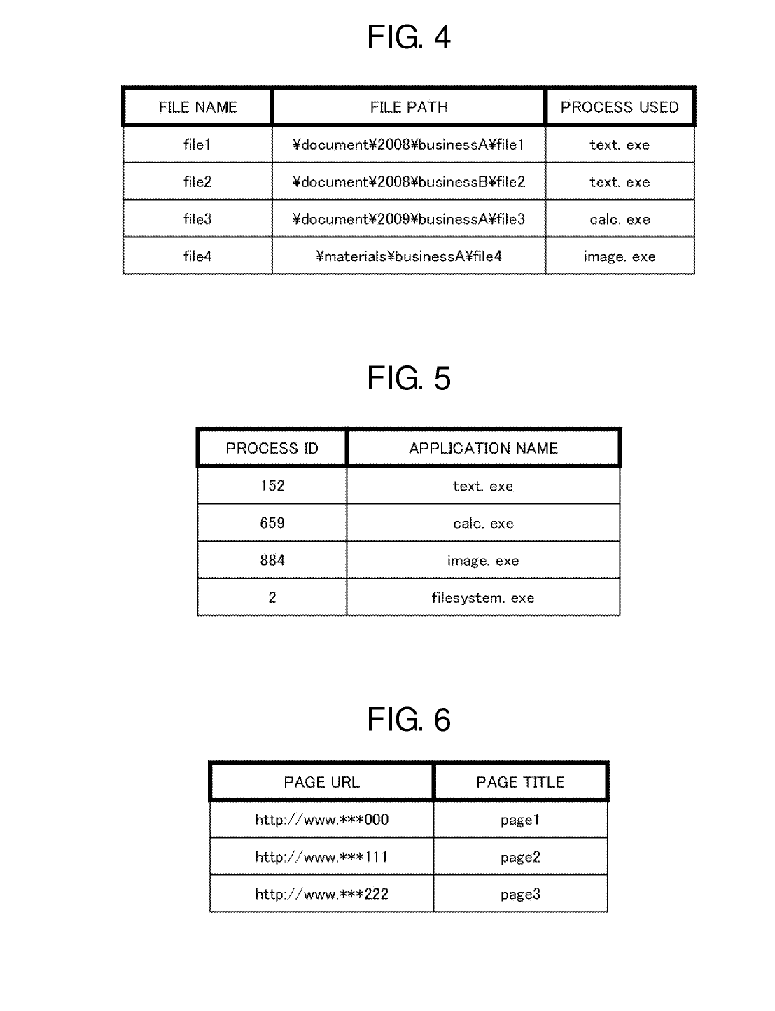

Referring to FIG. 4, a specific example of file access information held by the file access monitor unit 5 is described. As shown in FIG. 4, the file access information according to this embodiment includes information of three types: accessed file name; file path indicating the stored location (positional information) of the file in the data file memory unit 4; and name of the application software for the process accessing to the file. That is, for example, the first data shown at the topmost row in the table in FIG. 4 represent that a file having the name of “file 1” stored in the path of “¥document¥2008¥business A¥file 1” in the data file memory unit 4 is accessed by the application software of “text.exe.”

When detecting the file access to the file stored in the data file memory unit 4, the file access monitor unit 5 collects information on the accessed file and retrieves the information as the file access information. Similarly, when detecting the end of the file access, the file access monitor unit 5 removes information on the file finishing the access from the file access information. This makes the file access information holding only information on the files currently having the file access. At step S201 for detection of the file saving, the file access monitor unit 5 detects the file access as interpreting saving of the files if the contents of the file are changed during the file access or for the file finishing the file access. For example, as step S108 in FIG. 2, this corresponds to a case that the file contents edited with the file editing software are saved.

In returning to FIG. 3, if saving the file is detected, the file access monitor unit 5 calls and starts the state retrieval unit 8 (step S202). The file access monitor unit 5 transfers to the state retrieval unit 8 the file access information for the file detected at that time, or namely the file whose contents are changed, as the saved file information (at step S203).

After receiving the saved file information after starting, the state retrieval unit 8 starts state retrieving processing. First, the state retrieval unit 8 retrieves the file access information held by the file access monitor unit 5, and retrieves information of the file or files being accessed currently (step S204). In a case where the retrieved file access information contains the saved file information received at step S203, the state retrieval unit 8 removes information on the saved file information from the file access information. The reason of this removal is that if the saved file is accessed again, the state resuming operation is made, and that there are possibilities such that the same file is doubly accessed or such that no file is accessed where the save file is already accessed during the state resuming operation.

Subsequently, the state retrieval unit 8 retrieves the process information from the process monitor unit 7 at step S205. The process monitor unit 7 monitors the process (or processes) operating in the processing apparatus 16 likewise the file access monitor unit's detection of the file access, and holds the information on the process. The process monitor unit 7 detects start and end of the application software as shown in, e.g., step S102 in FIG. 2 and retrieves and renews the information on the process currently operating in the processing apparatus 16.

FIG. 5 is a specific example of the process information held at the process monitor unit 7. The process information according to the embodiment is structured of two elements: process ID and application name. The process ID is an identification number identifying the process operating in the processing apparatus 16, and is assigned with a value in a way that two or more processes do not have the same process ID at the same time. That is, for example, if the same application software is boosted in a plural number, the processes having the same application name exist in the plural number, but those processes can be distinguished from each other because the respective processes are assigned with different values. The application name is a tile of the application software operating in the process.

After retrieving the process information, the state retrieval unit 8 selects the process information to retrieve the webpage information subsequently (step S206). More specifically, the state retrieval unit 8 selects one coinciding to the name of the application software of a specific web browser among the application names of the retrieved process information. With this step, the state retrieval unit 8 selects only the specific web browser in the process in operation.

Using the selected process information, the state retrieval unit 8 retrieves webpage information via the page information retrieval unit 6 at step S207. The page information retrieval unit 6 requests information on the webpage or webpages that the process currently displays at the output device 14, to the currently operating process using the process ID of the process information received from the state retrieval unit 8. The page information retrieval unit 6 transfers the retrieved webpage information to the state retrieval unit 8.

FIG. 6 shows a specific example of the webpage information retrieved by the page information retrieval unit 6. The webpage information is structured of two elements; the page URLs representing the positional information or address of the webpage on the network; and the page title corresponding to the name when the webpage is displayed. For example, the first data shown at the topmost row in the table in FIG. 6 represents a webpage having: “http://www.***000” of the URL, and “page 1” of the page title. It is to be noted that the page information retrieval unit 6 judges the type of the application software of the web browser using the application name of the process information to perform suitable retrieving processing, because the processing method for retrieving the webpage information from the operating process may be varied according to the application software of the web browser as the origin of the retrieval. The state retrieval unit 8 retrieves the webpage information via the page information retrieval unit 6 for all of the process information selected at step S206. The state retrieval unit 8 also holds, at that time, relationship information that which webpage information is retrieved and from which process information the information is retrieved.

When the information retrieval is completed, the state retrieval unit 8 produces saved state data integrating information necessary for resuming the file currently accessed and the webpage displayed on the output device 14 from the retrieved information at step S208.

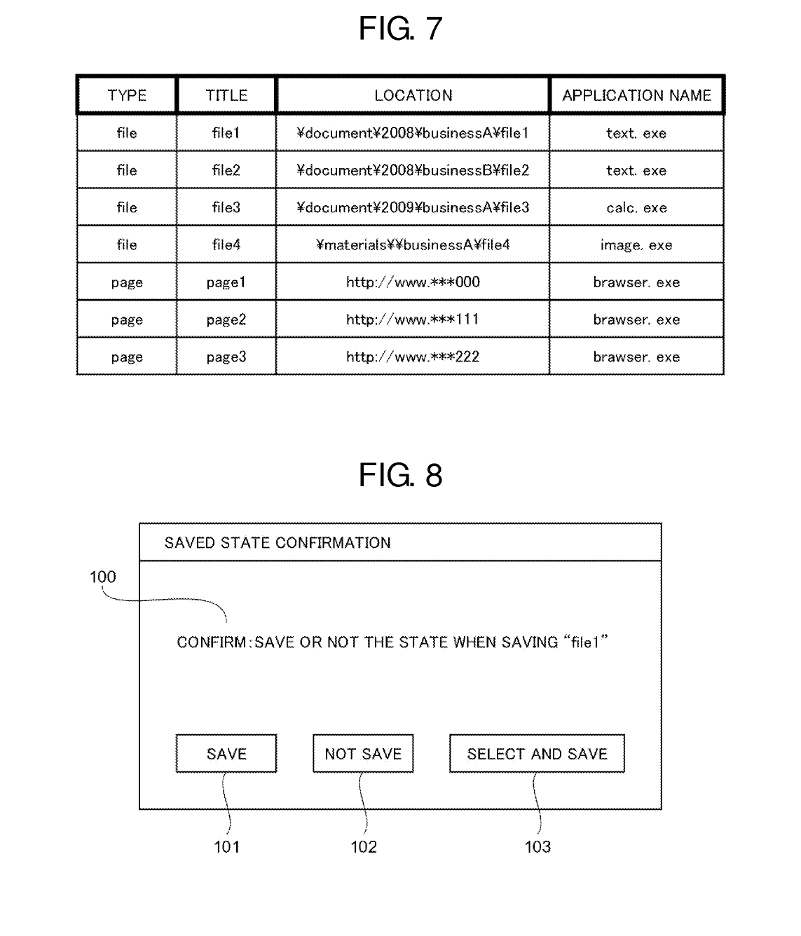

FIG. 7 is a specific example of the saved state data produced by the state retrieval unit 8. The saved state data are represented as a set of information constituted of four elements: type, title, location, and application name. The type is an element for distinguishing the data between information for file and information for webpage. The title is an element registered with a file name in the file access information if it is for the file or registered with a page title in the webpage information if it is for the webpage. The location is an element registered with a file path in the file access information if it is for the file or registered with a page URL in the webpage information if it is for the webpage. The application name is an element registered with a used process in the file access information if it is for the file or registered with an application name in the process information used for retrieving the webpage information in having the relationship at step S207 in FIG. 3 if it is for the webpage.

When the saved state data are produced at step S208, the state retrieval unit 8 calls and starts the state reserving unit 9, and transfers the produced saved state data and saved file information retrieved at step S203. This is the end of processing done by the state retrieval unit 8, and the following steps are handled by the state reserving unit 9.

When boosted and receives the saved state information and the saved file information from the state retrieval unit 8, the state reserving unit 9 renders the output device 14 display the saved state confirmation message box, or screen at step S209.

FIG. 8 is a specific example of the saved state confirmation message box displayed at the output device 14 by the state reserving unit 9. The file name of the saved file information is displayed at a portion of “file 1” in a message portion 100. The user can understand which saved file is going to be subject to state saving by confirming the display of the saved state confirmation message box. Buttons 101, 102, 103 are structured to be selectable for one button by the user through the input device 13. The processing at step 210 is branched according to the selected result by the user.

Where the user selects the button 102 (at step S210, “not save”), the state is not saved, and the state reserving operation is ended. To the contrary, where the user selects the button 101 (at step S210, “save”), the state reserving unit 9 renders the state memory unit 10 store the saved state data (at step S214). The state reserving unit 9, at that time, stores the saved state data in the state memory unit 10 as a single file. It is to be noted that where the file name of the saved state data is set as a file name including information of “strings indicating the saved state data+the file name of the saved file information+day and time stored in the state memory unit 10” such as, e.g., “saved state_file1_{—}20120101,” distinction can be made with ease.

Subsequently, the state reserving unit 9 sets a relationship between the file of the stored saved state data and the saved file (step S215) and stores the relationship data in the relationship memory unit 11 (step S216).

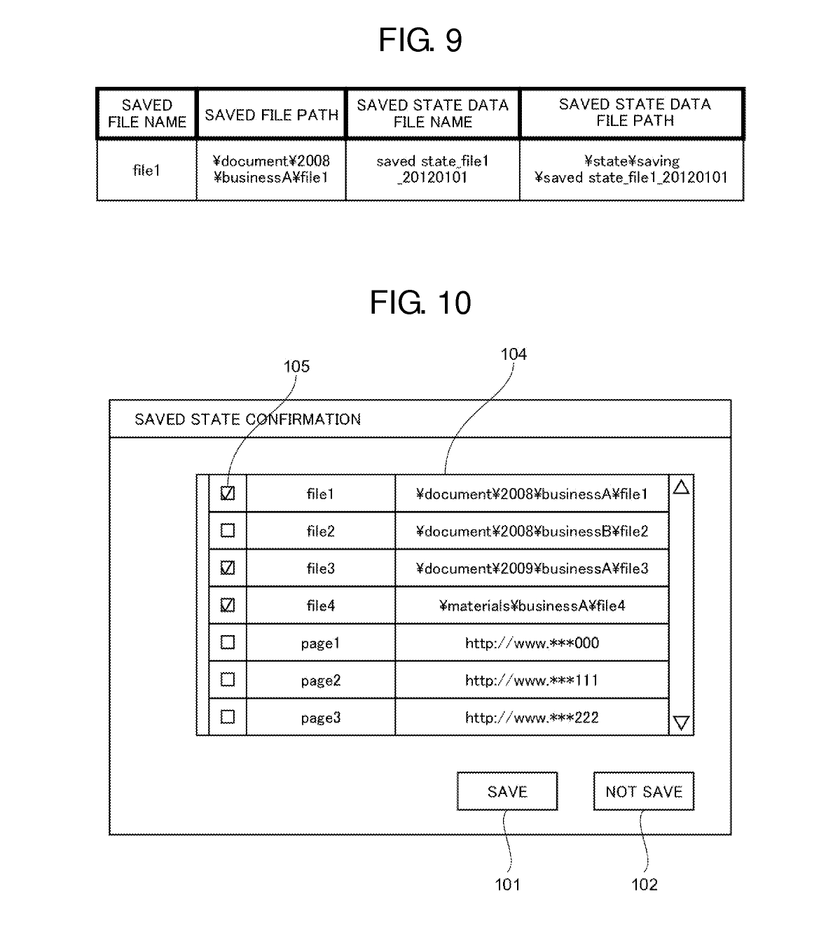

FIG. 9 is a specific example of the relationship data set with the state reserving unit 9. The relationship data are represented as a set of information constituted of four elements: saved file name, saved file path, saved state data file name, and saved state data file path. The file name and the file path in the saved file information are set respectively to the saved file name and the saved file path; the file name in the saved state data stored at step S214 in FIG. 3 is set to the saved state data file name; the positional information storing the saved state data file in the state memory unit 10 is set to the saved state data file path. The positional information of the saved state data file may be set as a storing destination at a time when the saved state data are stored in the state mu10 at step S214 in FIG. 3. The data stored by the relationship memory unit 11 are made as a summarized single file from the set of the relationship data as shown in FIG. 9.

Where the relationship data are stored in the relationship memory unit 11, the state reserving unit 9 adds to a certain file the relationship data to be stored if the file already exists in the relationship memory unit 11. The state reserving operation finishes when storing the relationship data is already completed and when saving the state is completed.

At step 210, if the user chooses the button 103 (step S210, “select and save”), selection and saving for selecting whether the user wants to save the files and webpages in the saved state data, respectively, is processed. The state reserving unit 9 first renders the output device 14 display the saved state confirmation message box (step S211).

FIG. 10 is a specific example of the saved state confirmation message box displayed at the output device 14 by the state reserving unit 9. At a saved content list 104, the information on the files and webpages of the saved state data is displayed in a listing format. Check boxes 105 on the left end of respective lines of the list are formed so that a user enters or not a check to select the item or items. The buttons 101, 102 have substantially the same functions as those displayed as the saved state confirmation message box shown in FIG. 8, so that any detailed description is omitted by providing the same reference numbers.

The processing at step S212 is branched according to the result selected by the user. When the user selects the button 102 (at step S212, “not save”), the state is not saved in substantially the same manner as that at step S210, the state reserving operation is ended. To the contrary, when the user manipulates the checkbox or checkboxes 105 (at step S212, “select and save”), the state reserving unit 9 holds the selection states of respective data of the saved state data and switches the states of the data. The state reserving unit 9 changes the check status indication in the checkbox or boxes 105 displayed on the saved state confirmation message box.

When the user selects the button 101 (at step S212 “save”), the state reserving unit 9 confirms the selection states of the respective data of the saved state data switched by the manipulation of the checkbox or boxes 105, and deletes the unselected data from the saved state data (at step S213). Because the following processing from step S214 to S216 is substantially the same processing as that described above except use of the saved state data from which the unselected data are deleted, any detailed description is omitted herein.

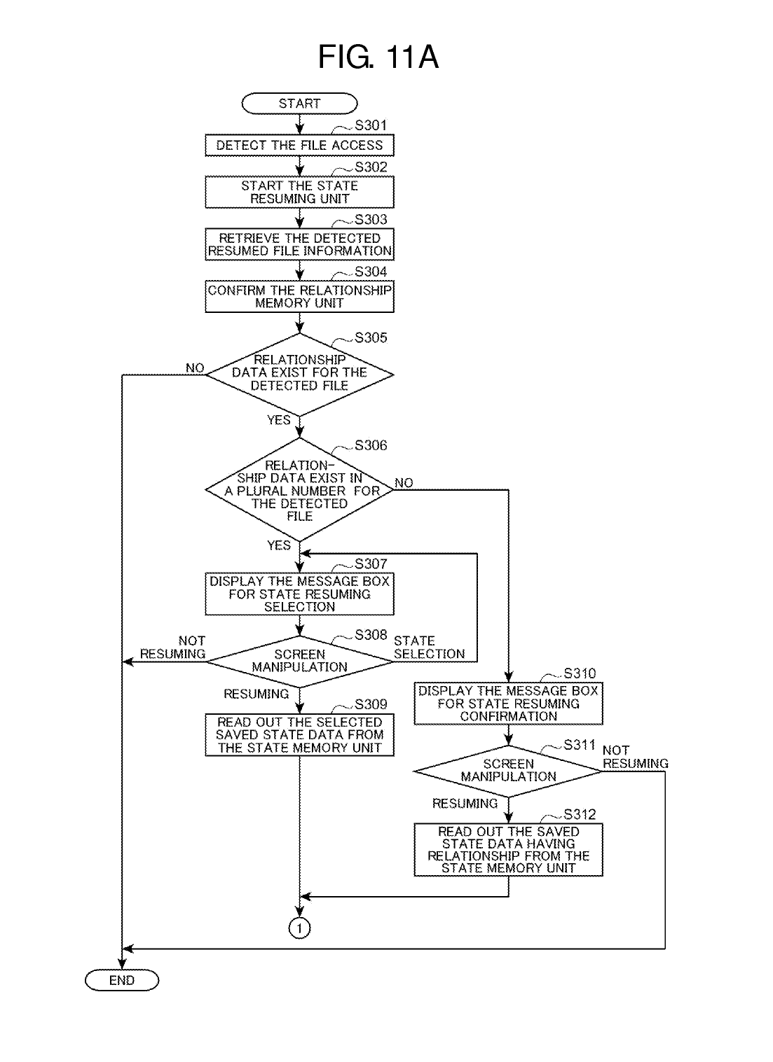

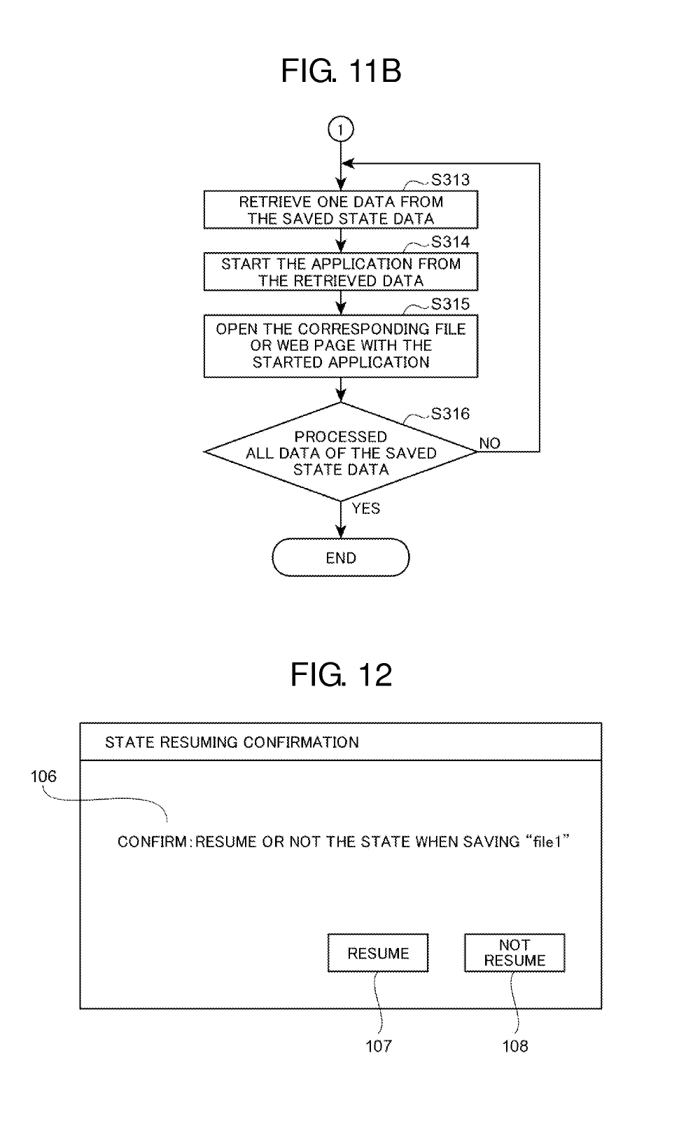

Finally, the state resuming operation is described using a flowchart shown in FIG. 11A and FIG. 11B.

The state resuming operation starts when the file access monitor unit 5 detects a file access (at step S301). The file access monitor unit 5 starts upon the detection of the access to the file stored in the data file memory unit 4, collects information on the accessed file, and retrieves the data as the file access information. For example, this corresponds to a case such that the file editor accesses a file and retrieves the contents of the file as shown at step S104 in FIG. 2.

At that time, the file access monitor unit 5 calls the state resuming unit 12 and makes the unit 12 start (step S302). The file access monitor 5 transfers to the state resuming unit 12 the file access information on the detected file, or namely the accessed file at that time as resuming file information (step S303).

After starting and receiving the resuming file information, the state resuming unit 12 begins the state resuming operation. The state resuming unit 12 retrieves the relationship information stored in the relationship memory unit 11, and searches the relationship data matching the file name and the file path in the resuming file information (step S304). If no relationship data matching the resuming file information exist (step S305, “No”), the state resuming operation ends because no saved state data in a resuming state exist.

To the contrary, if the relationship data matching the resuming file information exists (step S305 “Yes”), the state resuming unit 12 makes the processing proceed differently depending on whether the relationship data matching the resuming file information exist in a plural number (step S306).

If the number of the relationship data matching the resuming file information is only one (step S306), the state resuming unit 12 renders the output device 14 display the state resuming confirmation message box (step S310).

FIG. 12 is a specific example of the state resuming confirmation message box displayed on the output device 14. At a portion of “file 1” in a message portion 106, the file name of the resuming file information is displayed. The user can confirm as to which file is going to be resumed with the saved state by confirming the display of the state resuming confirmation message box. Buttons 107, 108 are formed to select either one by the user via the input device 13. According to the user's selected result, the processing at step S311 proceeds differently.

If the user selects the button 108 (step S311 “not resume”), resuming the state is not executed, and the state resuming operation ends. To the contrary, if the user selects the button 107 (step S311 “resume”), the state resuming unit 12 accesses to the saved state data stored in the state memory unit 10 from the relationship data matching the resuming file information and retrieves the contents of the data (step S312). The state resuming unit 12 executes operation to reopen the files and webpages from the retrieved saved state data after the following step S313. Herein, processing in a case that the relationship data matching the resuming file information exist in a plural number at step S306 (step S306, “Yes”), is described first.

In a case that the relationship data matching the resuming file information exist in a plural number (step S306, “Yes”), the state resuming unit 12 renders the output device 14 display the state resuming confirmation message box (step S307).

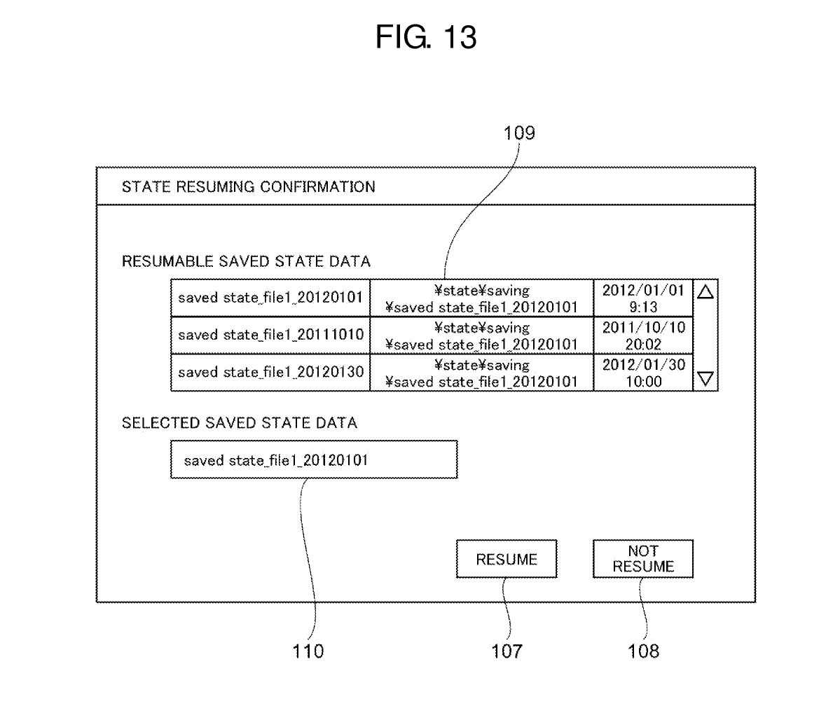

FIG. 13 is a specific example of the state resuming confirmation message box displayed on the output device 14 by the state resuming unit 12. Because the buttons 107, 108 are substantially the same as those on the state resuming confirmation message box shown in FIG. 12, any detailed description is omitted herein. A saved state data list 109 is for displaying, in a listing format, information of the saved state data retrieved from the plural relationship data matching the resuming file information. In this embodiment, the example is shown with saved state data file name and saved state data file path of the relationship data, as well as file modified day and time of the saved state data stored in the state memory unit 10. As described for the state reserving operation at step S214 in FIG. 3, it is possible for users to distinguish the differences of the saved state data with less amount of the information such as, e.g., only the saved state data file name by making the file name of the saved state data to be a name easily distinguishable by users. The saved state data list 109 is structured to select any one row by the users via the input device 13. The processing at step S308 proceeds differently according to the user's selected result.

When the user selects one of the saved state data from the saved state data list 109 (step S308, “state selection”), the state resuming unit 12 holds the relationship data corresponding to the selected saved state data. The state resuming unit 12 displays the selected saved state data file name at a selection result displaying portion 110, so that the user can confirm the currently selected saved state data.

On the other hand, when the user selects the button 108 (step S308, “not resume”), resuming the state is not executed, and the state resuming operation ends. When the user selects the button 107 (step S308, “resume”), the state resuming unit 12 accesses the saved state data stored in the state memory unit 10 from the relationship data holding the selection results selected by the user, and retrieves the contents of the data (step S309).

Processing subsequent to step S313 is described hereinafter. Because the retrieved saved state data are represented as a set of data structured of four elements of type, title, location, and application name, the state resuming unit 12 does processing on the data one by one (step S313).

The state resuming unit 12 first transfers the retrieved saved state data to the process resuming unit 15 and renders the unit 15 start. The process resuming unit 15 refers to the application name from the received saved state data and starts the application software to open the files and webpages (step S314).

More specifically, the process resuming unit 15 searches one matching the application name of the saved state data among the application software stored in the application memory unit 3, and renders the found application software operate at the processing apparatus 16. The process resuming unit 15 subsequently designates data of the location of the saved state data as the positional information of the files and webpages to the started application software, and makes accesses to the files and webpages to display the information (step S315).

The process resuming unit 15 can reproduce the state that all of the files and webpages saved during the state reserving operation are opened, by processing all of the saved state data retrieved by repeating the steps described above. The state resuming operation ends when all of processings on the saved state data are completed by the process resuming unit 15.

As described above, according to the first embodiment, when the saved files are accessed again, other files and webpages opened concurrently at that time can be reopened easily without any laborious step, by saving together information on other files and webpages concurrently opened when the file is edited and saved.

### Second Embodiment

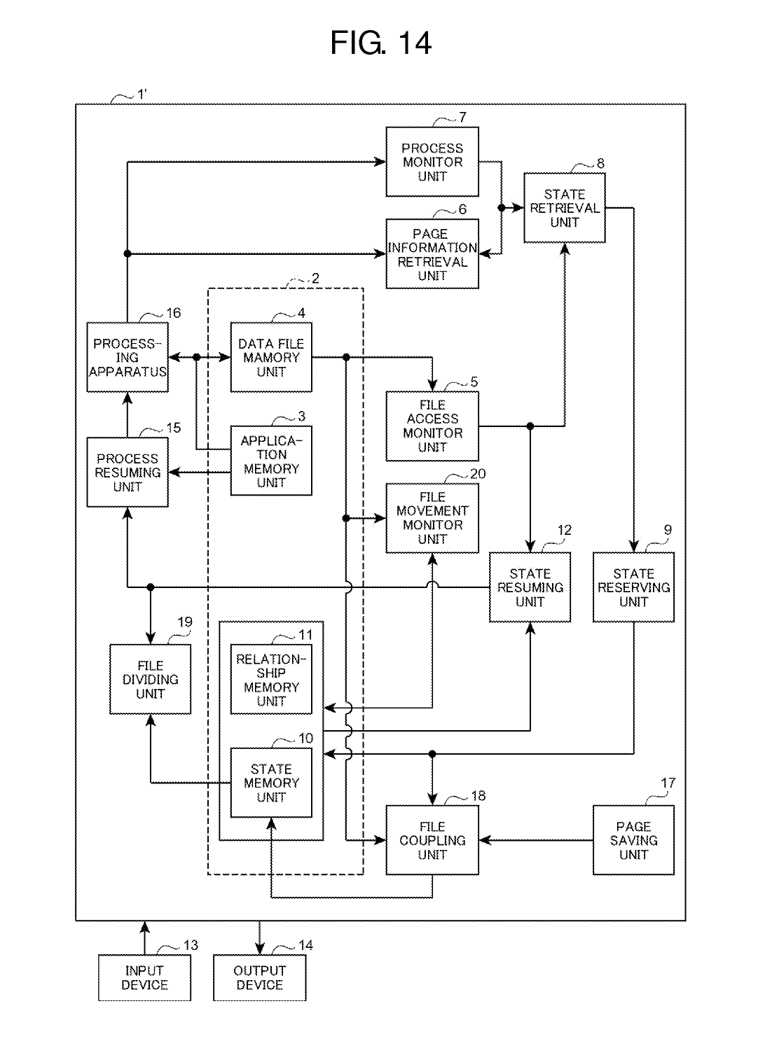

FIG. 14 is a block diagram showing a structural example of a terminal 1′ as an information processing apparatus according to the second embodiment of the invention. In the description about the terminal 1′ according to the embodiment, any detailed description is omitted by providing the same reference numbers to the same portions in the terminal 1 according to the first embodiment.

The terminal 1′ includes, in addition to the structure of the terminal 1, a page saving unit 17, a file coupling unit 18, a file dividing unit 19, and a file movement monitor unit 20.

The page saving unit 17 retrieves the contents of the webpages and saves them as a file or files.

The file coupling unit 18 receives the saved state data from the state reserving unit 9 and retrieves the files corresponding to these saved state data from the data file memory unit 4. The file coupling unit 18 retrieves the webpages corresponding to the webpage information summarized as the saved state data, as a file or files using the page saving unit 17, couples the saved state data and the retrieved files and webpages to save them as a file, and stores the file in the state memory unit 10.

The file dividing unit 19 reads out the file coupled by the file coupling unit 18, divides the file into the original files and original webpages, and transfers the divided file to the process resuming unit 15 to open the file.

The file movement monitor unit 20 monitors the movements of the files stored in the data file memory unit 10, refers to the relationship memory unit 11 if the file is moved, and renews the file's positional information after the file is moved if the moved file has the relationship data.

In operation of the terminal 1′ according to the second embodiment, operations for the terminal 1′ described herein are: general file editing operation for performing file manipulations in use of application software; state reserving operation for saving information on, at a time saving a file, other files in use concurrently, webpages being displayed concurrently, and operating application software; state resuming operation for activating the application software, using the file, and displaying the webpages using the saved data during the state reserving operation; and relationship renewing operation maintaining the relationship between the file state and the saved state data by modifying the corresponding relationship data at a time of the file movements. The general file editing operation is the same as that described in the first embodiment, so that any detailed description is omitted herein.

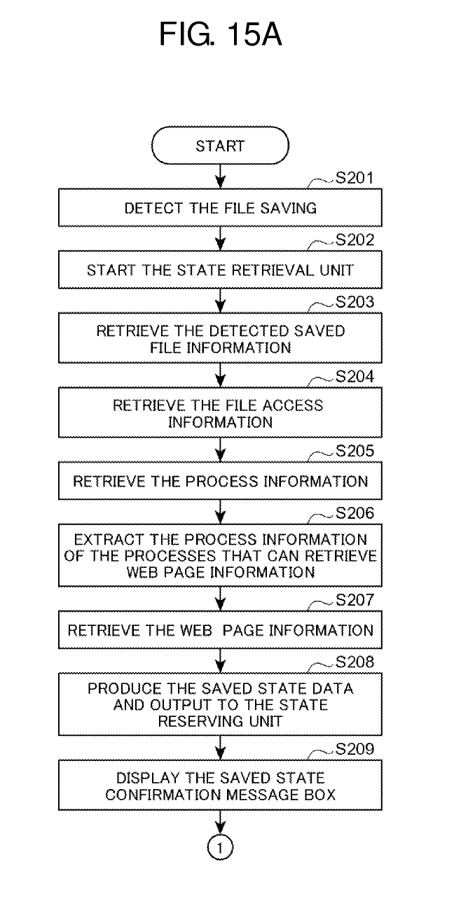

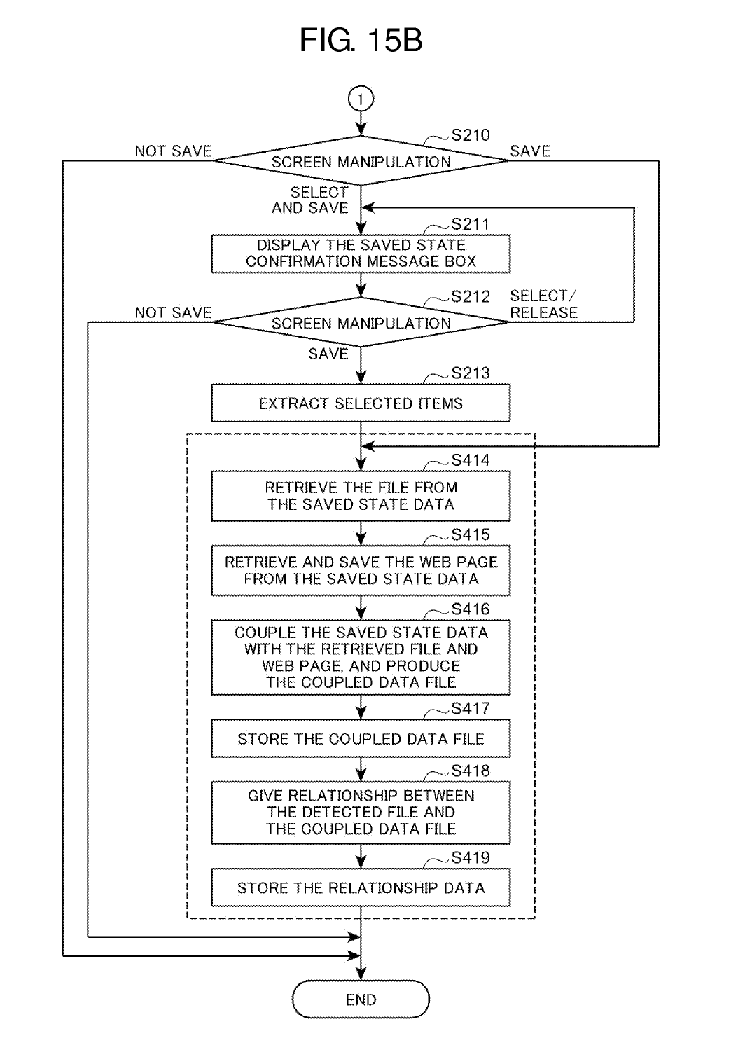

Referring to FIGS. 15A and 15B, a flowchart, the state reserving operation according to this embodiment is described.

The operations of steps S201 to S213 in FIGS. 15A, 15B are the same as those of steps S201 to S213 in FIG. 3, and any further description is omitted by assigning the same reference numbers.

At step S214, the state reserving unit 9 transfers the saved state data to the file coupling unit 18 and executes the file coupling processing. The file coupling unit 18 prepares files to be coupled when receiving the saved state data. That is, the file coupling unit 18 refers to the saved location of the saved state data with respect to the saved state data whose type is “file,” and accesses to the file stored in the data file memory unit 4 to retrieve the contents of the accessed file. The file coupling unit 18 supplies the location of the saved state data with respect to the saved state data whose type is “page” to the page saving unit 17, and retrieves the contents of the webpages via the page saving unit 17 (step S415).

More specifically, the page saving unit 17 performs communications with networks likewise the application software of the web browser exemplified at step S111 in FIG. 2, using the URLs of the supplied webpages, and retrieves the contents of the webpages to return the contents to the file coupling unit 18.

When all of the files and webpages in the saved state data are retrieved, the file coupling unit 18 couples all of the retrieved data with the saved state data, and produces a single coupled data file (step S417). The coupled data file is a file having, as the file contents, all of the retrieved files, contents of the webpages, and the saved state data.

The file coupling unit 18 stores the produced coupled data file in the state memory unit 10 (step S417). The following processing of providing relationships to the files and storing the data in the relationship memory unit 11 are substantially the same processing as those of step S215 to S216 in FIG. 3, and what is different is merely that the file stored in the state memory unit 10 is the file of the saved state data or the file of the coupled data (step S418 to S419).

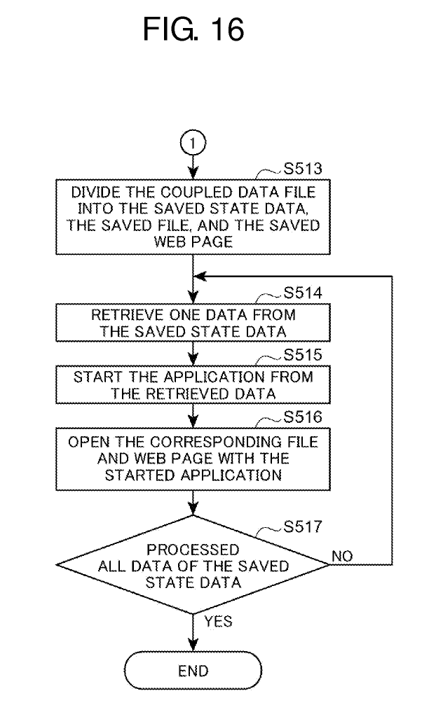

Subsequently, the state resuming operation is described using the flowchart in FIG. 11A and FIG. 16.

Similarly to the operation at the time of the state resuming in the description of the first embodiment, which is shown with two drawings of FIG. 11A and FIG. 11B, the operation at the time of the state resuming in this embodiment is described with two drawings of FIG. 11A and FIG. 16. That is, FIG. 11B in the first embodiment corresponds to FIG. 16 as described below. It is to be noted that the processing of step S301 to step S312 in FIG. 11A is the same as that in the first embodiment, so that any further detailed description is omitted. In this embodiment, the processing reopening the files and webpages after steps S513 in FIG. 16 is different from those in the first embodiment. At steps S309, S312, the state resuming unit 12 refers to the relationship data and reads out the files from the state memory unit 10. In the first embodiment, this read out file is the file of the saved state data, but is the coupled data file in this embodiment. The file dividing unit 19 reads out the coupled data file from the state memory unit 10, divides the file into the original files and webpages, and transfers the divided files to the process resuming unit 15 to open the files.

More specifically, the file dividing unit 19 divides the coupled data file read out from the state memory unit 10, back into the contents of the saved state data, the files, and the webpages, and renders the respective elements obtained by this division to be stored in the state memory unit 10 as a file again (step S513). The data of the location of the saved state data, at that time, are changed based on the stored locations in the state memory unit 10 of the data file of the files and the webpages stored in the state memory unit 10. The processing to display the files and webpages on the output device 14 (step S514 to step S517) subsequent to the following start of the application software using the divided saved state data, is substantially the same as the processing of step S313 to step S316 in FIG. 11B. Because the information in the locations of the files and webpages in the saved state data is modified as to refer to the data file of the divided files and webpages at step S513, the state resuming unit 12 can display the contents of the files and webpages at the time of saving the state via the output device 14, regardless the state of the files and webpages at the time of resuming the state.

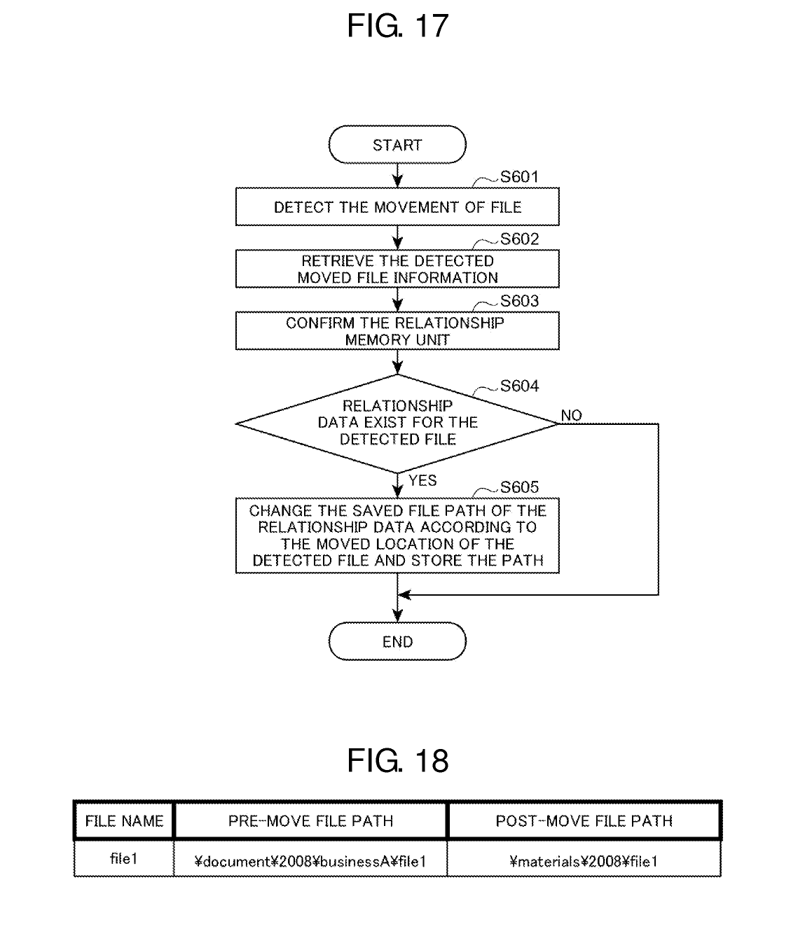

Finally, the relationship renewing operation for renewing the relationship data at the time of file movements is described using the flowchart in FIG. 17.

The relationship renewing operation starts upon detection of the file movements by the file movement monitor unit 20 (step S601).

The file movement monitor unit 20 monitors the files stored in the data file memory unit 4. The file movement monitor unit 20 detects the file movements when the file is moved, collects information on the detected moved files, and retrieves the information as the moved file information (step S602).

FIG. 18 is a specific example of the moved file information retrieved by the file movement monitor unit 20. The moved file information is structured of three elements: file name, pre-move file path (or source file path), and post-move file path (or destination file path).

The file movement monitor unit 20 retrieves the relationship data stored in the relationship memory unit 11, and searches the saved file name and the saved file path of the relationship data matching the file name and the pre-move file path of the moved file information (step S603). If no relationship data matches the moved file information (step S604, “No”), the relationship renewal is not required because no saved state data to resume the moved file exist, and the file movement monitor unit 20 ends the renewal operation. To the contrary, if the relationship data matching the moved file information exist (step S604, “Yes”), the file movement monitor unit 20 changes the saved file path of the relationship data to the post-move file path of the moved file information, and renders the relationship memory unit 11 re-store the path to complete the relationship renewing operation. This operation allows the relationship data to be renewed even where the file is moved, thereby maintaining the relationship.

In the first embodiment, the relationship between the saved file and the saved state data of the information on the files and webpages opened concurrently is managed with file's positional information. In such a case, the relationship of the saved state data may be cut off, and resuming the state may not be available, where the file's saved location is changed after the file is saved. Similarly, because the information on the files and webpages of the saved state data is managed by memorizing the positional information, resuming cannot be done if the saved location of the files and webpages is changed. In a case where the contents of the files and webpages are changed after the saved state data are saved, contents different from those at the time of saving the state may come even where the files and webpages are opened during the state resuming operation, and there may not reproduce the state at the time of saving the file.

To the contrary, with the second embodiment, the information processing apparatus can surely reproduce the state, even where the save file is moved, by monitoring the file movement and by renewing and maintaining the relationship information.

Although in the description of the embodiments according to the invention, all of the respective structural elements forming the invention are provided in the same terminal, this invention is not limited to this structure. For example, those structural elements can be distributed into plural terminals to build an information processing system connecting the plural terminals in a way through the networks. In the structures shown in FIG. 1 or FIG. 14, the structures indicated as the terminal 1, the terminal 1′, the processing apparatus 16, the input device 13, the output device 14, and the respective units contained in the storage unit 2 other than the respective structural elements can be formed by realizing operation of one or more of the application software stored in the application memory unit 3 having substantially the same functions via the processing apparatus 16.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An information processing apparatus comprising:
a file saving unit for saving a first file;
a state saving unit for saving, as saved state information, a second file's state at a time that the first file is saved in which the second file is opened at the time that the first file is saved; and
a state reproducing unit for reproducing the second file's state to be the state at the time that the first file is saved based on the saved state information where the first file is opened after the first file is saved.

2. The information processing apparatus according to claim 1, wherein the state saving unit further saves, as the saved state information, a third file's state at a time that the first file is saved in which the third file is opened at the time that the first file is saved, and wherein the state reproducing unit further reproduces the third file's state to be the state at the time that the first file is saved based on the saved state information where the first file is opened after the first file is saved.

3. The information processing apparatus according to claim 2, wherein the second file is opened with a first application whereas the third filed is opened with a second application.

4. The information processing apparatus according to claim 3, wherein the first application is a word processor.

5. The information processing apparatus according to claim 3, wherein the second application is a web browser.

6. The information processing apparatus according to claim 1, wherein the file saving unit is realized by a word processor.

7. The information processing apparatus according to claim 2, wherein the state saving unit saves, as the saving state information, either or both of the second file's state and the third file's state at the time that the first file is saved in a selectable manner in which either or both of the second file and the third file are opened at the time that the first file is saved.

8. An information processing apparatus for accessing a file produced in use of a prescribed application and for editing and saving the file, the information processing apparatus comprising:
a file access monitoring unit for detecting an access to the file;
a state retrieving unit for retrieving information on the file being opened, on a webpage opened together with the file, and on a prescribed application being activated;
a state saving unit for saving the information retrieved with the state retrieving unit as saved state information and for producing and saving relationship information on a relation between the saved file and the saved state information, in a case where the file access monitoring unit detects the access to the file for saving;
a process activating unit for activating the prescribed application to open the designated file and webpage; and
a state reproducing unit referring to the saved state information based on the relationship information to open the corresponding file and webpage with the process activating unit in a case where the file access monitoring units detects a re-access to the saved file.

9. The information processing apparatus according to claim 8, further comprising a file move monitoring means for detecting a move of a saving location of the file and for renewing the relationship information on the relation between the moved file and the saved state information.

10. The information processing apparatus according to claim 8, further comprising:
a file unifying unit for unifying the opened file and the webpage opened together with the file into a single file based on the retrieved information by the state retrieving unit to save the information as united data; and
a file dividing unit for dividing the united data into contents of the file and webpage before unified and for reopening the divided file and webpage with the process activating unit.
